(19) United States
(12) Patent Application Publication
(10) Pub. No.: US 2008/0099622 A1
(43) Pub. Date: May 1, 2008

(54) Accessory for vehicle

(75) Inventor: Meir Yoffe, Holon (IL)

Correspondence Address: NATH & ASSOCIATES, 112 South West Street, Alexandria, VA, 22314, US

(73) Assignee: ISRAEL AEROSPACE INDUSTRIES LTD, Lod (IL)

(21) Appl. No.: 11/812,301

(22) Filed: Jun. 18, 2007

(30) Foreign Application Priority Data
Jun. 28, 2006 (IL) 176597

(51) Int. Cl. B64D 7/00; F41F 5/00; B64D 1/02

(52) U.S. Cl. 244/137.4

(57) ABSTRACT

External store systems and assemblies for a carrier vehicle are provided. In some embodiments, the system includes a plurality of external store elements, each external store element comprising a plurality of surfaces defining an exterior thereof, the surfaces comprising at least one face, and a mounting arrangement configured for enabling reversible mounting of the elements to form at least one external store assembly having at least one of electrical continuity and aerodynamic conformality between adjacent external store elements, and for reversibly attaching the external store elements to a carrier vehicle.

### FIELD OF THE INVENTION

This invention relates to external stores carried on vehicles, especially air vehicles.

### BACKGROUND OF THE INVENTION

There are a wide variety of aircraft and other vehicles (for example land or sea faring vehicles) for which low observability (LO), particularly in terms of radar signature (typically measured in terms of Radar Cross Section—RCS), is important. Such aircraft or vehicles are sometimes referred to as stealth aircraft or vehicles. For example, U.S. Pat. No. 5,250,950 discloses a vehicle in free space or air, with external surfaces primarily fashioned from planar facets. The planar facets or panels are angularly positioned to reduce scattered energy in the direction of the receiver. In particular, radar signals which strike the vehicle are primarily reflected at an angle away from the search radar or are returned to the receiver with large variations of amplitude over small vehicle attitude changes.

External stores may present an undesirable radar signature for such LO aircraft and other aircraft, and this has been addressed in a number of ways including: storing the stores internally rather than externally; and enclosing the stores in an openable low radar signature tube. For example, U.S. Pat. No. 4,829,878 discloses an apparatus for carrying stores such as missiles and the like in a manner which permits the stores to be selectively deployed from a conformal or semi-conformal carriage position, with respect to a mobile vehicle, such as an aircraft, to a launch position from which the stores may be selectively launched, and including apparatus for selectively jettisoning the stores. In EP 1375345, a system is disclosed having a number of control units, some of which are for separating the lower longitudinal part of the low radar signature tube from the top part which is connected to the external body of the aircraft via a pylon, such that it creates in the tube, by its separation, an opening allowing the complete ejection of the missile. The weapon system is carried by a stealth aircraft, and is said to have a low radar signature tube which is radar absorbing, with a missile located inside this tube.

### SUMMARY OF THE INVENTION

According to a first aspect of the invention, an external stores system, comprising a cluster or assembly of external stores, is provided that provides low observability (LO), in particular low signature including radar signature (e.g. in terms of RCS) and/or optical signature (avoiding glinting in diffuse directions, for example), and/or is attached to a carrier vehicle such as an aircraft, for example in a conformal manner.

Accordingly, the invention relates to an external store system for a carrier vehicle, comprising:
a plurality of external store elements, each external store element comprising a plurality of surfaces defining an exterior thereof, said surfaces comprising at least one facet; and
a mounting arrangement configured for enabling reversible mounting of said elements to form at least one external store assembly having at least one of electrical continuity and aerodynamic conformality (or surface continuity) between adjacent external store elements, and for reversibly attaching said external store elements to a carrier vehicle.

In one embodiment, each said external store element comprises at least two substantially planar side walls joined to a substantially planar base, and a nose section comprised of a plurality of facets. Each said external store element may also comprise a plurality of deployable fins. Carriage lugs are also provided.

Each said external store element may comprise any one of a bomb, electronic or other pod, fuel tank, and the like.

The present invention also relates to an external store assembly for a carrier vehicle comprising an external store system according to the invention, in particular as set out above, said assembly being formed by a plurality of said elements arranged as pairs of juxtaposed adjacent elements, wherein a side surface of one element is facing a side surface of a juxtaposed adjacent element. In one embodiment, the elements each have a substantially triangular transverse cross section, though in other embodiments, the cross-sections may be of a different shape, for example polygonal, or indeed any other shape that provides a conformal configuration with respect to adjacent like elements. In one particular embodiment, particularly in which the elements comprise a triangular cross-section, the assembly comprises three said elements in side-by-side or juxtaposed relationship, providing a composite semi-hexagon configuration for the cross-section of the assembly. The mounting arrangement may comprise suitable lugs comprised on said side walls. In one particular embodiment, the elements each comprises a ridge transversely opposed to said base, and said mounting arrangement comprises suitable lugs comprised on said ridge.

In particular, the assembly may be configured such that facing side walls of each pair of adjacent said elements are in abutting contact such as to provide electrical continuity between said elements. Further in particular, facing free edges of facing side walls of each pair of adjacent said elements are in abutting contact such as to provide electrical continuity between said elements, which also provides continuity between the aerodynamic surfaces. In other embodiments, the facing side walls of each pair of adjacent said elements comprise a gap therebetween, and the assembly further comprises a suitable filler material or gasket accommodated in said gap, in particular at the facing edges, such as to provide electrical and optionally aerodynamic continuity between said elements.

The assembly may be mounted directly to a surface of said vehicle, particularly in a conformal manner with respect thereto. The assembly may be configured for providing electrical continuity with said vehicle when mounted directly to a surface of said vehicle, and the assembly may comprise a mating surface comprising said side walls of at least two said elements, and wherein said vehicle surface is substantially complementary to said mating surface. The assembly may comprise a mating surface comprising said side walls of at least two said elements, wherein said mating surface forms a gap with a vehicle surface when said assembly is mounted thereto: said assembly further comprises a suitable filler material or gasket accommodated in said gap such as to provide electrical continuity between said assembly and said vehicle surface.

Alternatively, the assembly may be mounted to said vehicle via a pylon arrangement.

In described embodiments, the mounting arrangement is configured for enabling selective and/or sequential deployment of individual said elements from said assembly. For example, the assembly may comprise three said elements in side by side or juxtaposed arrangement comprising a port element, a starboard element and a middle element, and wherein said mounting arrangement is configured for deployment of said middle element first from said assembly. Further, the mounting arrangement may be configured for deployment of at least one of said port element and said starboard element from said assembly after deployment of said middle element.

Optionally, the facets of the elements may comprise RCS reducing properties.

According to a second aspect of the invention, an external stores system, comprising one or more external stores, is provided that provide low observability (LO), in particular low signature including radar signature (e.g. in terms of RCS) and/or optical signature (avoiding glinting in diffuse directions, for example), and/or aerodynamic conformality when attached to a carrier vehicle such as an aircraft, for example, such that there is electrical continuity and/or surface continuity, respectively, between the vehicle and the external store(s).

Accordingly, the invention also relates to an external store system for a carrier vehicle, comprising at least one external store element comprising a plurality of surfaces defining an exterior thereof, said surfaces comprising at least one facet; and
an attachment arrangement configured for enabling reversible attachment of the or each said external store element to a carrier vehicle while maintaining at least one of electrical continuity and aerodynamic continuity between the or each said external store element and an adjacent external surface of the carrier vehicle, in particular between free edges of the or each external store element and the external surface of the carrier vehicle.

Each store element may be as disclosed above according to the aforementioned first aspect of the invention.

The present invention also relates to a carrier vehicle, comprising at least one external store system according to the first aspect of the invention, attached thereto.

The present invention also relates to a carrier vehicle, comprising at least one external store system or assembly according to the second aspect of the invention, attached thereto.

In either case, the carrier vehicle may comprise, for example, any one of an air vehicle such as an aircraft for example, water-borne craft, hovercraft, land vehicles, space vehicles. In some embodiments, the carrier vehicle is an aircraft, and the external store system or assembly is mounted to an underside or upper side of a wing or of a fuselage thereof, or indeed any other suitable external surface. Optionally, the carrier vehicle may be configured for minimizing RCS therefrom.

The present invention also relates to a method for carrying a plurality of external stores on a vehicle, comprising:
(a) forming each said stores as an element having a configuration comprising a plurality of surfaces defining an exterior thereof, said surfaces comprising at least one facet;
(b) assembling the elements to form at least one external store assembly having at least one of electrical continuity and aerodynamic continuity between adjacent elements; and
(c) mounting said assembly to the vehicle.

For some types of stores, step (a) may be replaced with the following step:-
enclosing each said stores in an element having a configuration comprising a plurality of surfaces defining an exterior thereof, said surfaces comprising at least one facet.

The assembly may be mounted to said vehicle in a manner such as to maintain electrical continuity between the assembly and an adjacent external surface of the vehicle and/or aerodynamic conformity. In particular, electrical continuity and surface continuity is maintained between free edges of the assembly and an adjacent external surface of the vehicle.

The present invention also relates to a method for selectively deploying a plurality of external stores from a carrier vehicle, comprising:
carrying a plurality of external stores in the form of an assembly mounted to the vehicle according to the invention;

selectively deploying a desired said element by disconnecting said desired said element from said assembly and/or said vehicle, while maintaining at least one of electrical continuity and aerodynamic continuity at least between remaining said elements of said assembly.

In particular, electrical continuity and/or aerodynamic conformality is maintained between free edges of the assembly and an adjacent external surface of the vehicle.

The present invention also relates to a method for carrying at least one external store on a vehicle, comprising:
(A) forming the or each said stores as an element having a configuration comprising a corresponding external store element comprising a plurality of surfaces defining an exterior thereof, said surfaces comprising at least one facet; and
(B) mounting the or each said external store element to the vehicle while maintaining at least one of electrical continuity and aerodynamic continuity between the or each said external store element and an adjacent external surface of the vehicle.

For some types of stores, step (a) may be replaced with the following step:-
enclosing the or each said stores in an element having a configuration comprising a corresponding external store element comprising a plurality of surfaces defining an exterior thereof, said surfaces comprising at least one facet

A feature of at least some embodiments of the invention, particularly for applications of the invention directed to mounting the assembly onto a surface of the carrier vehicle, where the carrier vehicle is aerodynamic, for example a non-stealth or a stealth aircraft, is that the assembly according to the invention provides aerodynamic advantages, in particular drag reduction, compared with that of the configuration obtained when mounting the elements separately and individually to the aircraft, for example in rows, columns, etc, or as compared with clusters, where such elements are not joined to one another and do not provide electrical continuity or aerodynamic conformality.

Another feature of at least some embodiments of the invention is that the external stores elements of an assembly according to the invention may be designed for minimizing RCS individually, as well as in an assembly, and/or when mounted to the carrier vehicle in conformal manner, without necessitating in many cases any modification of the external contours or aerodynamic shape of the vehicle, and in many cases making use of hard points or mounting points already existing in a fuselage or wing, for example. By way of example, an aircraft comprising pylons for carryings stores may be modified to carry an assembly or single element according to the invention by removing the pylon from the wing, and modifying the pylon attachment points on the wing structure to instead enable the assembly or element to be releasably mounted thereto.

Yet another feature of at least some embodiments is that the external store elements may be designed in a modular and conformal manner such that each element may occupy any position in the assembly according to the invention. On the one hand the elements may be mutually conformal one with another when in adjacent relationship in the assembly, either exclusively by virtue of having substantially complementary geometries in the mutually abutting areas thereof, or by having a suitable gasket material therebetween, in any case providing electrical continuity between the elements in the assembly. In particular, electrical continuity is maintained between free edges of the assembly and an adjacent external surface of the vehicle.

On the other hand the elements may be mutually conformal with respect to the aircraft surface (or any other surface of a carrier vehicle) when the assembly, or indeed parts thereof (for example after deployment of some elements of the assembly) are in adjacent relationship in the assembly, either exclusively by virtue of having substantially complementary geometries in the mutually abutting areas thereof, or by having a suitable gasket material therebetween, in any case providing electrical continuity between the assembly and the surface on which the assembly is mounted.

Electrical continuity herein means that electrical conductance between two adjacent components is provided, either by conforming the abutting components or surfaces with respect to one another to avoid gaps between components, or between surfaces thereof, or between edges thereof, or combinations thereof, or by providing a conductive material to fill the gaps between components or surfaces, wherein the open gaps would otherwise represent surface discontinuities that produce a noticeable radar cross-section. The electrical continuity provided between the surfaces or components significantly reduces the radar cross section with respect to that obtained in a comparable configuration comprising untreated gaps that do not provide such electrical conductance.

Herein, “conformal”, “aerodynamic conformality” and the like, in the context of an external stores element or an assembly thereof, for example, refers to the geometry of the geometric interface between such elements or assembly and the structure to which it is attached follows the contour or profile of that structure. Such an interface is thus appropriately contoured such as to provide aerodynamic continuity: between the separate external store elements within an assembly thereof; between the individual elements that are attached to a surface of a vehicle and the vehicle; between an assembly of said elements that is attached to a vehicle and the vehicle; and so on.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates in cross-sectional front view, an embodiment of an assembly of external stores elements according to the invention mounted to an undersurface of a carrier vehicle such as an aircraft according to one aspect of the invention.

FIG. 2 illustrates in top/front isometric view one external stores element of the embodiment of FIG. 1. FIG. 2a illustrates a detail of a mounting arrangement of the embodiment of FIG. 2.

FIG. 3 illustrates in front view one external stores element of the embodiment of FIG. 1.

FIG. 4 illustrates in cross-sectional view a mounting arrangement for the embodiment of FIG. 1.

FIG. 5 illustrates in front and partial cross-sectional view another mounting arrangement for the embodiment of FIG. 1.

FIG. 6 illustrates in isometric view, another embodiment of an external stores element according to the invention mounted to a surface of a carrier vehicle such as an aircraft.

FIG. 7 illustrates in cross-sectional front view the embodiment of FIG. 6.

FIGS. 8(a) to 8(c) schematically illustrate a deployment sequence for the embodiment of FIG. 1.

FIG. 9 illustrates in cross-section view, the embodiment of FIG. 1 mounted to a carrier vehicle such as an aircraft via a pylon arrangement according to one aspect of the invention.

FIG. 10 illustrates in front and partial cross-sectional view, the embodiment of FIG. 6 mounted to a carrier vehicle such as an aircraft via a pylon arrangement according to one aspect of the invention.

FIGS. 11(a) to 11(c) illustrates in front view a deployment sequence for elements of FIG. 2, arranged in a cluster of six elements and mounted to an undersurface of a carrier vehicle such as an aircraft according to an aspect of the invention.

FIG. 12 illustrates in front view, another embodiment of an assembly of external stores elements according to the invention mounted to an undersurface of a carrier vehicle such as an aircraft according to one aspect of the invention.

FIG. 13 illustrates in front view, another embodiment of an assembly of external stores elements according to the invention mounted to an undersurface of a carrier vehicle such as an aircraft according to one aspect of the invention.

### DETAILED DESCRIPTION OF EMBODIMENTS

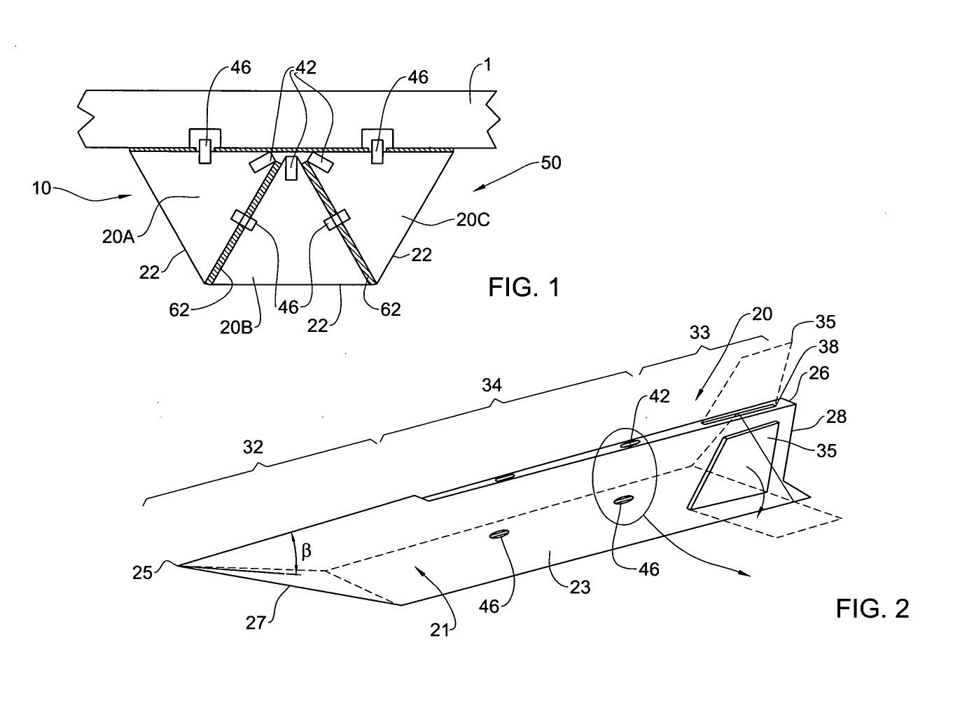

An external store system for a carrier vehicle according to an embodiment of the invention is illustrated in FIGS. 1 to 5, and is generally designated with the numeral 10. The carrier vehicle 1 may be any suitable vehicle capable of carrying the system 10, and may include, by way of non-limiting example, any one of: an air vehicle such a regular civil or military aircraft, stealth aircraft, water-borne craft, hovercraft, land vehicles, space vehicles, and so on. More specifically, the system 10 may be carried on any suitable external part of the vehicle, for example over or under a wing, over or under a fuselage, and so on, particularly where the vehicle 1 is an aircraft or other air vehicle.

In the embodiment of FIG. 1, the system 10 comprises a low observable (LO) external store cluster or assembly 50, comprising three substantially identical, external store modules or elements 20A, 20B, 20C, each of which is also referred to herein by the collective numeral 20. Optionally, the elements 20 are modular, and are interchangeable one with the other within the assembly 50. Each external store element 20 may the same or a different type, one from another. Furthermore, each external store element 20 may be configured for any suitable application, for example, and not limited to, fuel tanks, pods (including for example, ecm pods, camera pods, gun pods, as bombs, etc.), and so on, and thus while internally different one from the other according to the specific application, the external form may be substantially similar.

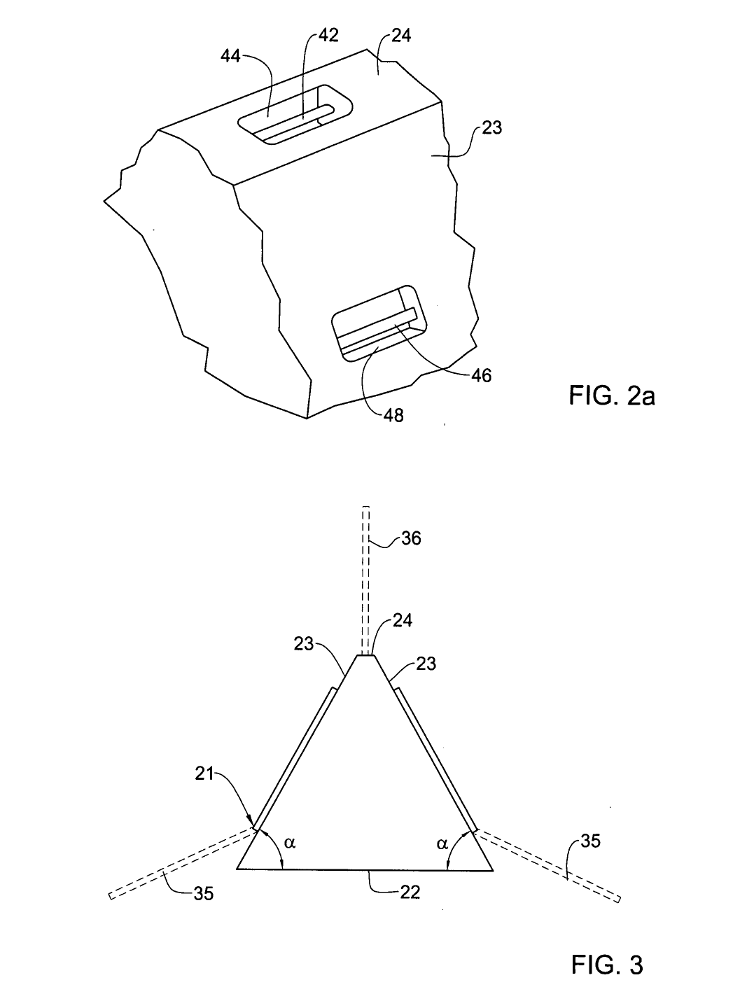

Referring to FIGS. 2 and 3 in particular, each external stores element 20 comprises faceted externally facing surfaces 21, which serve to effectively reduce the signature, including radar signature (e.g. in terms of RCS) and/or optical signature, of each element 20. In particular, each element 20 comprises a substantially triangular transverse cross-section, defined by a number of facets including a substantially planar base wall 22 and two substantially planar side walls 23 inclined thereto at angle α, which in the illustrated embodiment is about 60°. In other embodiments, the value of angle a may be different from 60°, being greater or less than 60°, and in yet other embodiments the value of angle a may be different for each of the side walls 23 for a particular element 20. A narrow ridge 24 opposed to the base defines the apex of the triangular cross section, and extends from, or aft of, the leading edge 25 to the trailing edge 26 or close thereto of the element 20. The trailing section 28 of the element may include a plurality of facets facing in a generally aft direction, for example in a similar manner to that of the forward section 32 mutatis mutandis. A substantially planar inclined wall 27 joins the base wall 22 to the leading edge 25 at an angle β to the longitudinal axis of the element, which in this embodiment is substantially parallel to the ridge 24, and thus the side walls 23 comprise a generally rectangular aft portion and a right triangular forward portion.

The stores element 20, in particular the externally facing surfaces 21, may be made from any suitable electrically conducting material, for example aluminium, or suitable composite materials.

Optionally, the externally facing surfaces 21 may be radar-absorbing and/or comprise a radar-absorbing coating. Thus externally facing surfaces 21 may be made from a radar-absorbing material or comprise a radar-absorbing material.

Thus, the element 20 may be considered as comprising a forward or nose section 32 longitudinally serially connected to, or integrally formed with, a center section 34 and an aft section 33, the nose section 32 and optionally also the aft section 33 having the form of a tetrahedron, and the center section having the form of a generally triangular prism.

Depending on the particular use or application of the external store element 20, the nose section 32 may house, for example, a guidance system and/or a radar system and/or a reconnaissance system. The center section 34 and/or the aft section 33 may accommodate, for example, a payload and/or a warhead and/or a reconnaissance system. Optionally, and in other variations of this embodiment, the center section 34 and/or the aft section 33 may comprise a propulsion system, such as for example a rocket motor, ramjet engine, turbojet engine, and so on, together with a suitable fuel system.

Optionally, and in other variations of this embodiment, the element 20 is adapted for carrying fuel or another liquid, and thus comprises an internal volume for accommodating the fuel/liquid, and a suitable outlet for connection to a fuel system, for example, of the vehicle 1. In embodiments where the element 20 is adapted for carrying fuel, the element 20 may comprise suitable vents and a suitable interface for connecting to electrical, fuel and pressurizing lines comprised in the vehicle 1, which is thus also suitably adapted for having such an element 20 attached thereto.

Optionally, and in other variations of this embodiment, the element 20 comprises a weapon such as a bomb or missile, for example, and comprises suitable ordinance, for example explosive material, biological chemical or nuclear payload, fuses etc., as required therefor. Optionally, and in other variations of this embodiment, the element 20 is adapted as a platform for launching ordnance such as for example missiles or other weapons, and comprises suitable bays/launching apparatus therefore within the element, with suitable openings (optionally recloseable), for example longitudinal openings or transverse openings, for enabling deployment of the ordnance.

The aft section 33 optionally further comprises a plurality of stabilizing and/or control fins, including a pair of side fins 35 and an upper fin 36. The fins 35, 36 are deployable from a retracted position, in which the fins 35 are flatly abutting the corresponding side wall 23 and the upper fin 36 is housed in aft facing recesses 38 accommodated in the element 20, to a deployed position (shown in phantom lines in FIG. 2), in which the fins 35 and 36 are projecting outwardly from the aft section 33. Alternatively, all of the fins may be deployable from recesses in the element 20, or any other method as known in the art may be employed to selectively stow the fins in a compact configuration, and to selectively deploy the fins when required at the desired position and orientation with respect to the element 20. The fins 35 and 36 may be deployed having no dihedral, or having a negative or positive dihedral, according to the specific application of the element 20. Deployment of the fins 35, 36 may be achieved using any means known in the art, for example by a spring loaded mechanism, pyrotechnic means, and so on. The fins 35, 36 are optionally pivotable in a controlled manner about suitable journals (not shown) aligned with radial axes generally orthogonal with respect to a longitudinal axis of the element 20, to provide flight control to the air vehicle 10. It will be appreciated that in other embodiments, a different number of fins, or no fins at all, may be comprised on the element 20, typically depending on the specific requirements, mission and so on of the particular carrier vehicle 1, for example.

In any case, each element may comprise an external form that is aerodynamically compatible, and thus which induces the minimum drag possible, given the other constraints on its form, as disclosed herein, for example, while still having a faceted form.

Referring to FIG. 1, the system 10 further comprises a mounting arrangement configured for enabling reversible mounting of the elements to form at least one external store cluster or assembly 50 having electrical continuity and aerodynamic conformity between adjacent external store elements 20, and for reversibly attaching said external store elements to the carrier vehicle 1. The assembly 50 thus comprises three said elements 20, arranged together side by side such that each of the side walls 23 of the middle element 20B is facing a side wall 23 of one or another of the two outer elements 20A, 20C, generally forming a half hexagon in transverse cross-section. The mounting arrangement comprises suitable mounting means, including bomb ejection racks, hooks, lugs and so on, for example, for reversibly mounting or otherwise reversibly attaching the three elements 20A, 20B 20C to each other and/or to the vehicle 1. Referring particularly to FIGS. 2 and 2a, each element 20 comprises a pair of axially spaced suspension bars or lugs 42 in pockets 44 in the ridge 24. Further, each element 20 comprises an additional one or plurality of axially spaced suspension bars or lugs 46 in pockets 48 in each of the side walls 23. Thus, the laterally disposed elements 20A, 20C are reversibly attached to the vehicle 1, the lugs 46 on one side 23 thereof being configured for cooperating with complementary support hooks 45, for example, comprised on the carrier vehicle 1, for example directly on the underside of a wing or fuselage portion of an aircraft, such as a substantially flat surface, for example the upper or lower surface of a wing, or indeed any other suitable mold line, contour line or other extent that defines a surface of the vehicle 1. The support hooks 45 are configured for being retracted into the vehicle and to be covered with a cover or door, after the store is deployed, so as to maintain the clean aerodynamic and/or low observability characteristics of the vehicle.

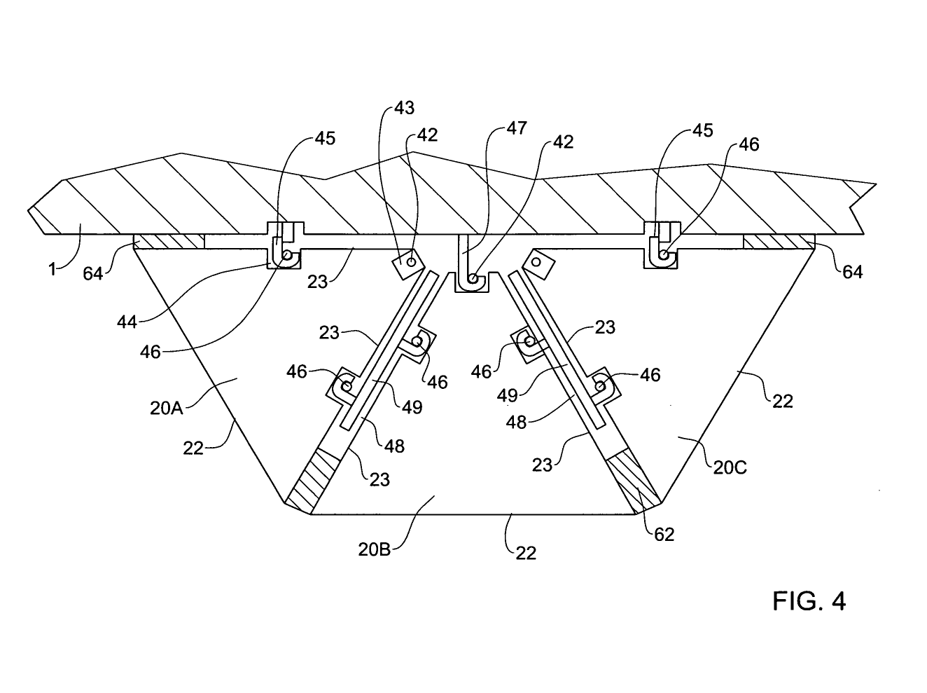

The middle element 20B may be attached to the vehicle 1, the lugs 42 being configured for cooperating with support hooks 47, for example, comprised on a carrier vehicle 1. Alternatively or additionally, the middle element 20B is reversibly attached to the adjacent elements 20A, 20C via the lugs 46 on facing pairs of side walls 23. For this purpose, and referring to FIG. 4 for example, a pair of mating elements 49 is provided, each being accommodated in a space 48 between the facing side walls 23 of adjacent pairs of elements 20A, 20B or 20B, 20C. The mating elements 49 each comprise a pair of retractable hook-like elements on each side thereof that cooperate with the corresponding lugs 46 on facing side walls 23 to connect the middle external stores element 20B to the adjacent elements 20A, 20C, and are controllable by suitable means (not shown) to selectively release the lugs 46 of the middle element 20B, after which the mating elements 49 may be discarded, or alternatively retracted within the carrier vehicle or the adjacent elements 20A and/or 20C, such that the mating elements 49 do not provide a significant radar or optical reflecting source. In this embodiment, electrical continuity is maintained between the adjacent external stores elements 20A, 20B and 20B, 20C via a suitable electrically conducting filler material or gasket 62, which is also discarded with the mating elements 49. The filler material or gasket 62 is provided around the full exposed periphery of the gap between the adjacent external stores elements 20A, 20B and 20B, 20C for reducing the radar return that would otherwise arise due to the gaps. By way of non-limiting example, suitable filler material may comprise, or gasket may be made from, for example, Eccosorb* SLJ rubbersheet absorber for X and KU bands, by Emmerson Cumming (formerly Grace), of, inter alia, the US, UK, France.

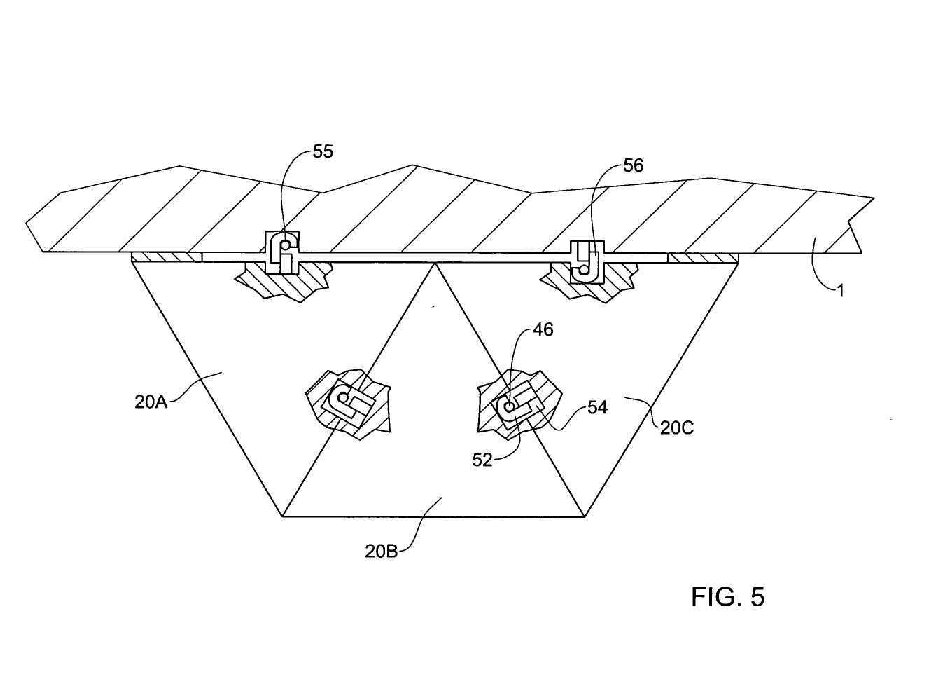

Alternatively, the elements 20 may be adjacently reversibly mutually attachable one to another without the need for said mating elements 49. For example, and referring to FIG. 5, rather than having a pair of axially spaced lugs 46 on each side wall 23, one such lug is replaced with a release element such as for example retractable support hook 52 accommodated in a suitable well 54. Thus, a support hook 52 of element 20C reversibly engages the lug 46 of a facing side wall 23 of element 20B and vice versa, a support hook 52 of element 20B reversibly engages the lug 46 of a facing side wall 23 of element 20A and vice versa, a support hook 52 of element 20A reversibly engages the lug 55 comprised on the vehicle 1 and vice versa, which also comprises a support hook 56 for reversibly engaging the lug 46 of a facing side wall 23 of element 20C, and vice versa. A suitable control system is provided for controlling operation of each of the support hooks to enable selective and sequential deployment of each of the elements 20A, 20B, 20C according to a desired sequence. Alternatively, explosive bolts may be used for connecting/disconnecting the elements 20A, 20B, 20C to one another and/or to the vehicle 1. In such embodiments, one or both of the lateral elements 20A, 20C comprises suitable control lines providing communication between the air vehicle and the release elements, so that a release command or signal may be provided to the central element 20B via one or the other or both of the lateral elements 20A, 20C.

According to an aspect of the invention, the assembly 50 is connected directly to a surface of the vehicle, for example an aerodynamic lifting surface, such as for example the underside or upper side of a wing or of a lifting body, or for example other parts of the vehicle such as a fuselage of the vehicle, when the vehicle is an aircraft for example, in a substantially pylonless or non-embedded manner, also referred to herein as a “conformal manner”, such that the assembly essentially “sits” on a mating surface of the vehicle, and moreover a clean aerodynamic profile of the vehicle 1 in the mounting area thereof is restored after deployment of the assembly 50.

This vehicle mating surface may be planar or aerodynamically contoured, for example, and the assembly 50 is connected directly to the vehicle loading points within the wing, fuselage and so on, via the mounting arrangement discussed above, for example.

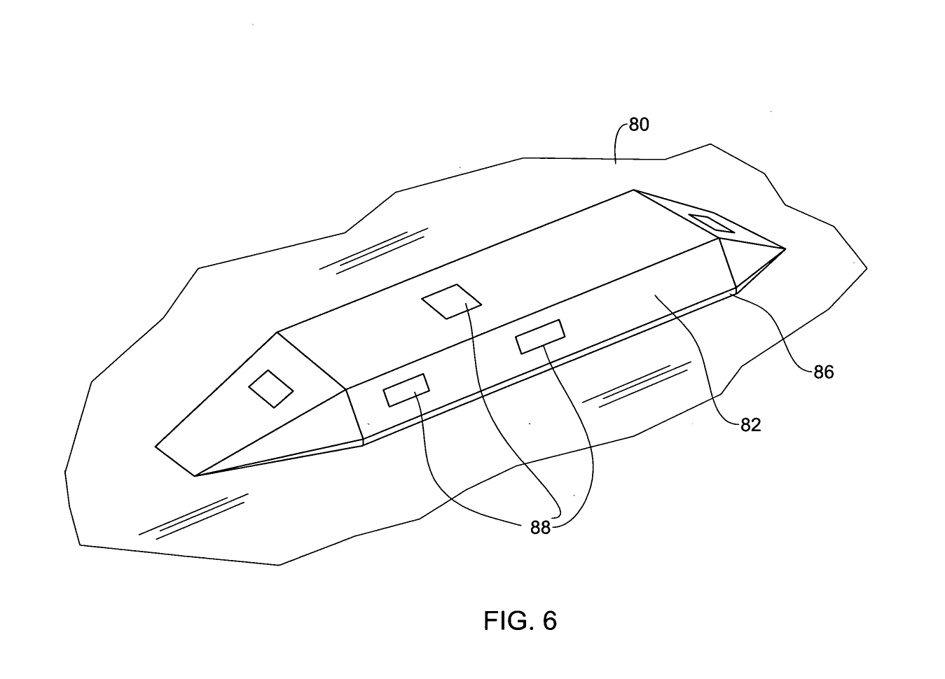

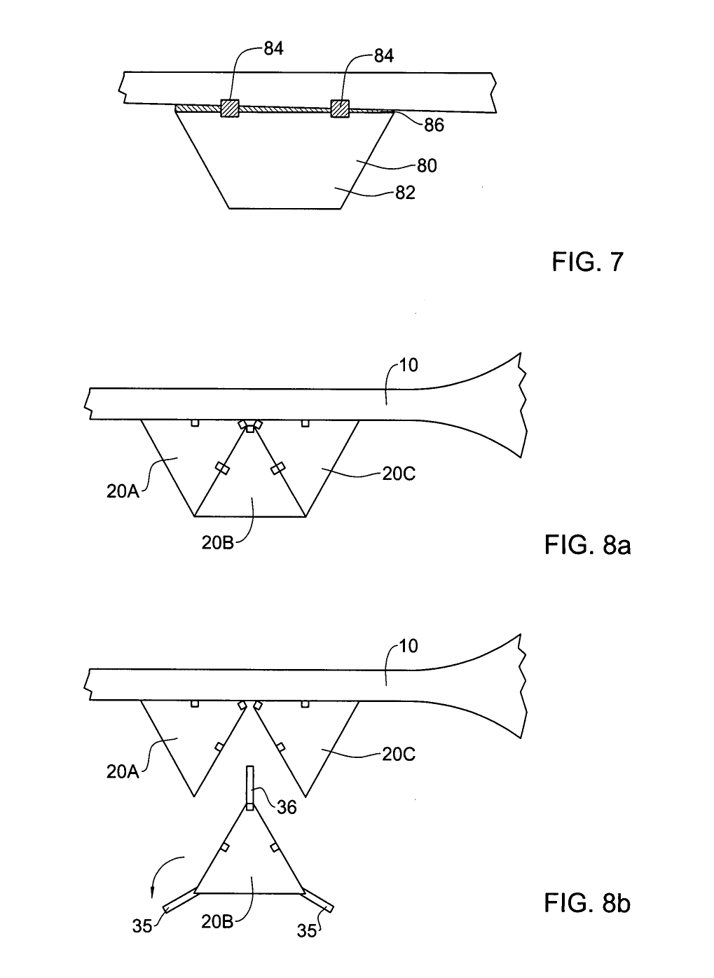

Electrical continuity may be maintained naturally where the vehicle surface is substantially flat and a facing side wall 23 of the elements 20A, 20C are abutted against the vehicle surface, or where the facing surfaces between the elements 20A, 20C and the vehicle surface are geometrically complementary. Alternatively, a suitable electrically conducting filler material or gasket 64 may be provided between the facing side walls 23 of the elements 20A, 20C and the vehicle surface, so that the assembly 50 indirectly abuts the vehicle surface via the gasket/filler material. According to this aspect of the invention, a single external stores element may also be reversibly attached to an external surface of the vehicle 1, the external stores element comprising a plurality of faceted surfaces for providing low observability. For example, a single or a plurality of mutually unconnected elements 20 may be reversibly mounted to a surface of the vehicle 1 in a manner such as to provide electrical continuity with the vehicle surface, while fully projecting therefrom. Alternatively, other embodiments may be provided for a singly attachable external store element. For example, and referring to FIGS. 6 and 7, an embodiment for a single external stores element 80 is illustrated, having a cross-section generally similar to that of the assembly 50 of the embodiment of FIG. 1. Other variations are of course possible, the element 80 comprising a plurality of facets 82 constituting the external surface of the element 80. Suitable mounting means 84 enable the upper side of the element 80 to be reversibly connected to the vehicle surface. In the particular embodiment illustrated in FIGS. 6 and 7, the element 80 comprises a substantially hemi-hexagonal transverse cross-section. Optionally, a suitable filler material or gasket 86 is provided between the element 80 and the vehicle to provide electrical continuity. Optionally, a number of access doors or panels 88 may be provided to allow selective communication between an inside of the element 80 and the outside thereof.

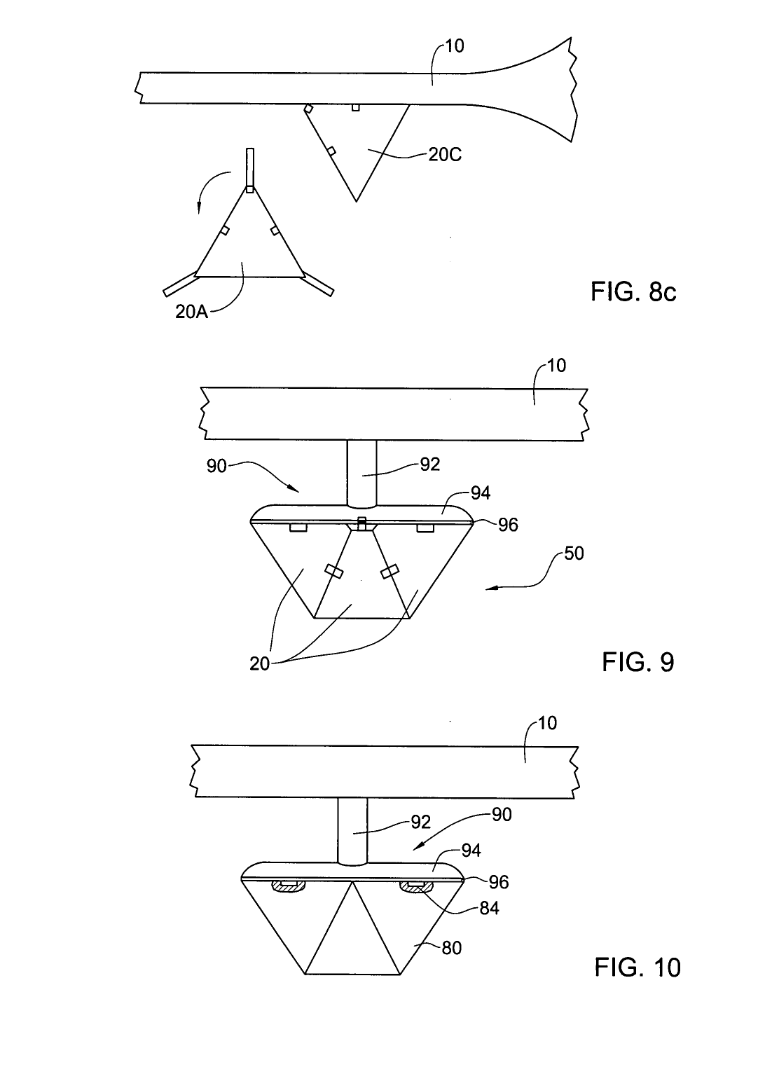

Referring to FIGS. 8(a) to 8(c), an example deployment sequence is illustrated for a cluster or assembly 50 according to the invention, the assembly 50 being mounted to an underside of a wing or fuselage of vehicle 1 in the form of an aircraft. Prior to any deployment, the assembly provides an electrically continuous entity, providing minimum RCS and minimum drag characteristics. The assembly comprises externally facing facets comprising the bases 22 and ramps 27 (and aft-facing portions) of each element 20, FIG. 8(a). The first element 20 that is deployed is the center element 20B (FIG. 8(b)), by releasing the mounting arrangement between this element and the adjacent elements 20A, 20C (directly or indirectly) and/or between the element 20B and the vehicle 1. This operation exposes the facing side walls 23 of the now adjacent elements 20A, 20C. As illustrated in FIG. 8(c), in the next part of the deployment sequence, one of the elements 20A (but may also be 20C instead, or simultaneously therewith) is deployed by releasing the corresponding mounting mechanism with respect to the vehicle, and this may be followed by deployment of the last element 20C. In each case, some time after release from the aircraft, as each element 20 in turn first separates from the carrier vehicle, the fins 35, 36 may be suitably deployed. After the last element 20C is deployed, the clean aerodynamic contour of the aircraft is restored. Thus, according to an aspect of the invention, the vehicle outer configuration, particularly aerodynamic configuration, is not compromised in order to conform the elements 20 or assembly 50 thereto, and thus enables relatively simple fitting to an aircraft body. Optionally, closable doors, flaps or the like may be provided in the vehicle for closing the openings formed therein for the mounting arrangement.

Thus, where the carrier vehicle comprises a relatively flat surface, the stores element(s) according to the described embodiments, having substantially flat side walls, may be directly mounted to the carrier vehicle surface in a conformal manner. In other carrier vehicles where no such suitable flat surface is available, an optional adaptor is provided having a vehicle facing surface that is complementarily contoured with respect to the particular surface of the vehicle onto which it is desired to mount the external stores, and a stores facing surface that enables the flat surfaces of the elements to be abutted thereto. Electrical continuity is maintained between the stores elements, adaptor and the vehicle surface as described herein, mutatis mutandis.

Optionally, and as illustrated in FIG. 9, in another aspect of the invention, the assembly 50 may be connected to the vehicle 1 via a pylon arrangement 90, for example, comprising a bomb ejection rack (BER), rather than directly to a vehicle surface, and is thus compatible with many existing external stores systems using pylons currently in use with many fixed wing and rotary wing aircraft for example. For this purpose the pylon arrangement 90 may comprise a pylon 92 projecting from the underside of the vehicle 1, and a fairing 94 covering suitable load bearing and attachment mechanisms, similar to those described for the embodiments of FIGS. 1 to 8(c) for example, mutatis mutandis, for attaching the assembly 50 to the pylon arrangement 90. A suitable gasket 96 or filler material may be provided between the assembly and the fairing 94 to maintain electrical continuity. By way of non-limiting example, suitable filler material may comprise, or gasket may be made from, for example, Eccosorb* SLJ rubbersheet absorber for X and KU bands, by Emmerson Cumming (formerly Grace), of, inter alia, the US, UK, France.

Deployment of each of the elements 20 can be effected in a sequential manner, for example in a similar manner to that as described for the embodiment of FIGS. 6(a) to 6(c), mutatis mutandis. Alternatively, and as illustrated in FIG. 10, the assembly 50 may be replaced, mutatis mutandis, with a single store element, for example the embodiment of FIGS. 6 and 7, such that there is electrical continuity and conformal carriage between the stores 80 and the pylon arrangement 90.

While the external stores assembly 50 has been described above in the context of three external stores elements of generally triangular cross section grouped together in a hemi-hexagon configuration (i.e., having a general transverse cross-section generally shaped as a half-hexagon), the invention is not restricted to such a configuration, and many other configurations are possible. For example, four such elements may be grouped together, each element having the cross-section generally similar to an isosceles triangle, with angle α being about 45° to provide a half-octagon as the composite cross-sectional area.

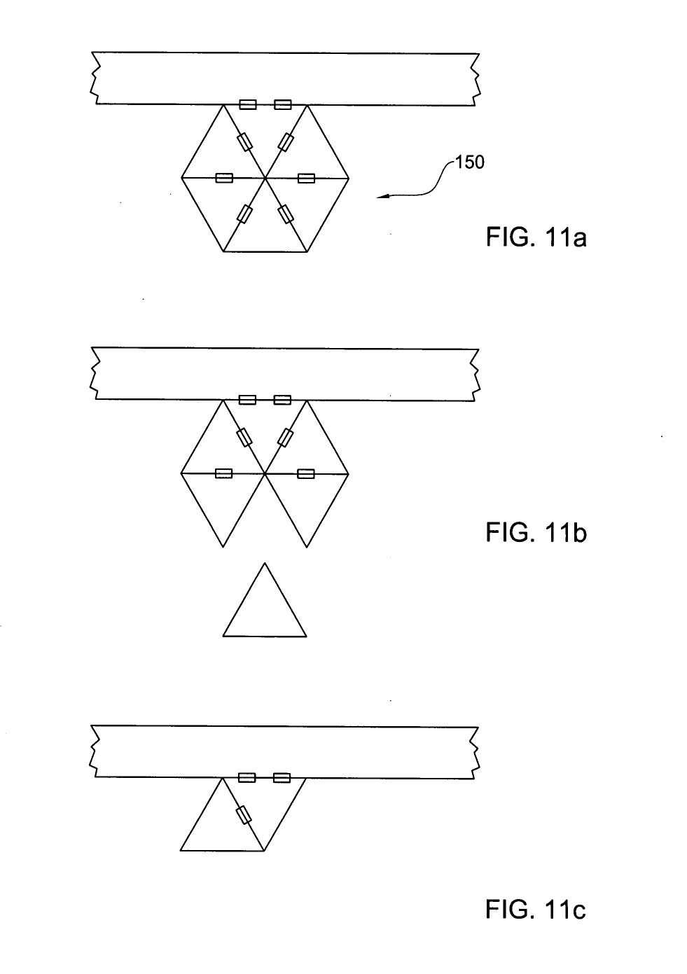

Alternatively, and as illustrated in FIGS. 11(a) to 11(c), six elements 20 may be grouped together to form an assembly 150 having a hexagonal composite cross section, the individual elements 20 being joined to one another and/or to the vehicle 1 in a manner similar to that described for the embodiment of FIGS. 1 to 5, mutatis mutandis. The assembly 150 may be carried on an underwing, overwing, underfuselage or above-fuselage portion of a vehicle 1, or indeed any other portion of the vehicle, particularly when the vehicle 1 is an air vehicle, and deployed therefrom in flight, for example, in the illustrated sequence, such that each time that one or more elements 20 is released from the assembly 150, while the remaining part of the assembly still provides electrical continuity with the vehicle, and offers LO via the exposed faceted surfaces of the assembly 150.

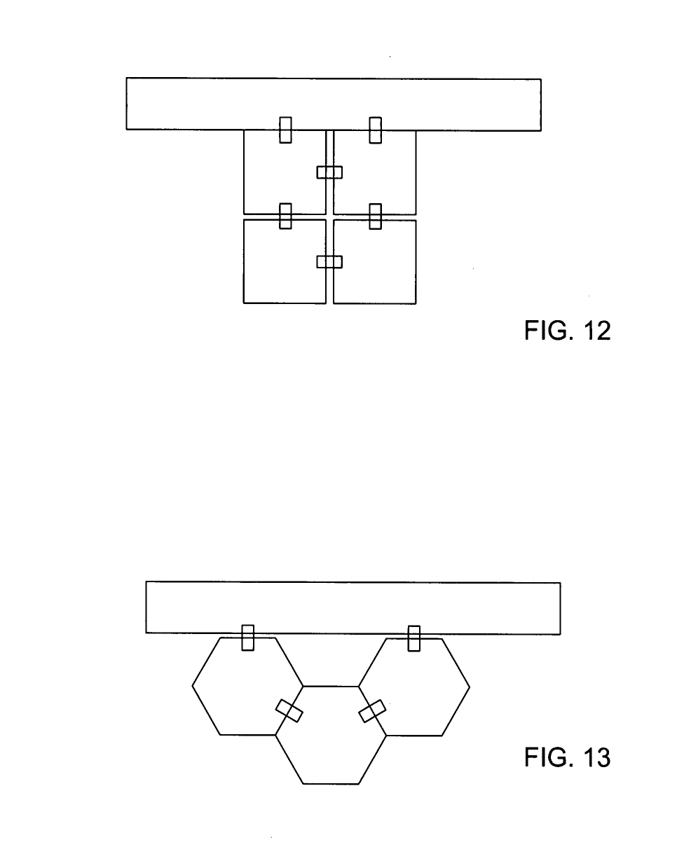

Alternatively, the stores need not comprise a triangular cross-section, and each external stores element may comprise a rectangular cross-section or a hexagonal cross-section, and a plurality of such elements may be grouped together according to the invention as illustrated in FIGS. 12 and 13, respectively, in a similar manner to the other embodiments disclosed herein, mutatis mutandis.

Further optionally, a plurality of clusters of stores and/or single stores according to the invention may be mounted in adjacent, juxtaposed or transversely spaced arrangement, and/or in tandem or longitudinally spaced arrangement, and/or in an array (rectangular or otherwise), on one or several surface of the vehicle 1.

Many other variations of the above embodiments according to the invention are also possible.

In the method claims that follow, alphanumeric characters and Roman numerals used to designate claim steps are provided for convenience only, and do not imply any particular order of performing the steps.

Finally, it should be noted that the word “comprising” as used throughout the appended claims is to be interpreted to mean “including but not limited to”.

While there has been shown and disclosed example embodiments in accordance with the invention, it will be appreciated that many changes may be made therein without departing from the invention.

1. An external store system for a carrier vehicle comprising:
a plurality of external store elements, each external store element comprising a plurality of surfaces defining an exterior thereof, said surfaces comprising at least one facet; and
a mounting arrangement configured for enabling reversible mounting of said elements to form at least one external store assembly having at least one of electrical continuity and aerodynamic conformality between adjacent external store elements, and for reversibly attaching said external store elements to a carrier vehicle.

2. An external store system according to claim 1, wherein each said external store element comprises at least two substantially planar side walls joined to a substantially planar base, and a nose section comprised of a plurality of facets.

3. An external store system according to claim 2, wherein each said external store element comprises a plurality of deployable fins.

4. An external store system according to claim 1, wherein each said external store element comprises any one of a pod, fuel tank, and the like.

5. An external store assembly for a carrier vehicle comprising an external store system according to claim 1, said assembly being formed by a plurality of said elements arranged as pairs of juxtaposed adjacent elements, wherein a side surface of one element is facing a side surface of a juxtaposed adjacent element.

6. An external store assembly according to claim 5, wherein said elements each have a substantially triangular transverse cross section.

7. An external store assembly according to claim 6, said assembly comprising three said elements in juxtaposed relationship.

8. An external store assembly according to claim 5, wherein said mounting arrangement comprises suitable lugs comprised on said side walls.

9. An external store assembly according to claim 5, wherein said elements each comprise a ridge transversely opposed to said base, and wherein said mounting arrangement comprises suitable lugs comprised on said ridge.

10. An external store assembly according to claim 5, wherein said facing side walls of each pair of adjacent said elements are in abutting contact such as to provide electrical continuity between said elements.

11. An external store assembly according to claim 5, wherein said facing side walls of each pair of adjacent said elements comprise a gap therebetween, and further comprising a suitable filler material or gasket accommodated in said gap such as to provide electrical continuity between said elements.

12. An external store assembly according to claim 5, wherein said assembly is mounted directly to a surface of said vehicle.

13. An external store assembly according to claim 12, wherein said assembly is configured for providing electrical continuity with said vehicle when mounted directly to a surface of said vehicle.

14. An external store assembly according to claim 13, wherein said assembly comprises a mating surface comprising said side walls of at least two said elements, and wherein said vehicle surface is substantially complementary to said mating surface.

15. An external store assembly according to claim 13, wherein said assembly comprises a mating surface comprising said side walls of at least two said elements, and wherein said mating surface forms a gap with a vehicle surface when said assembly is mounted thereto, said assembly further comprising a suitable filler material or gasket accommodated in said gap such as to provide electrical continuity between said assembly and said vehicle surface.

16. An external store assembly according to claim 5, wherein said assembly is mounted to said vehicle via a pylon arrangement.

17. An external store assembly according to claim 5, wherein said mounting arrangement is configured for enabling selective and/or sequential deployment of individual said elements from said assembly.

18. An external store assembly according to claim 17, wherein said assembly comprises three said elements in juxtaposed arrangement comprising a port element, a starboard element and a middle element, and wherein said mounting arrangement is configured for deployment of said middle element first from said assembly.

19. An external store assembly according to claim 18, wherein said mounting arrangement is configured for deployment of at least one of said port element and said starboard element from said assembly after deployment of said middle element.

20. An external store system according to claim 1, wherein said facets comprise RCS reducing properties.

21. An external store assembly according to claim 5, wherein said facets comprise RCS reducing properties.

22. An external store system for a carrier vehicle, comprising at least one external store element comprising a plurality of surfaces defining an exterior thereof, said surfaces comprising at least one facet; and
an attachment arrangement configured for enabling reversible attachment of the or each said external store element to a carrier vehicle while maintaining at least one of electrical continuity and aerodynamic conformity between the or each said external store element and an adjacent external surface of the carrier vehicle.

23. A carrier vehicle, comprising at least one external store system as defined in claim 1, attached thereto.

24. A carrier vehicle, comprising at least one external store system as defined in claim 22 attached thereto.

25. A carrier vehicle, comprising at least one external store system as defined in claim 5, attached thereto.

26. A carrier vehicle according to claim 23, said carrier vehicle comprising any one of an air vehicle, water-borne craft, hovercraft, land vehicles, space vehicles.

27. A carrier vehicle according to claim 26, wherein said carrier vehicle is an aircraft, and wherein said external store system is mounted to an underside or upper side of a wing or of a fuselage thereof.

28. A carrier vehicle according to claim 23, wherein said carrier vehicle is configured for minimizing RCS therefrom.

29. A method for carrying a plurality of external stores on a vehicle, comprising:
forming each said stores as an element having a configuration comprising a plurality of surfaces defining an exterior thereof, said surfaces comprising at least one facet;
assembling the elements to form at least one external store assembly having at least one of electrical continuity and aerodynamic conformality between adjacent elements; and
mounting said assembly to the vehicle.

30. A method according to claim 29, wherein said assembly is mounted to said vehicle in a manner such as to maintain electrical continuity between the assembly and an adjacent external surface of the vehicle.

31. A method for selectively deploying a plurality of external stores from a carrier vehicle, comprising:
carrying a plurality of external stores in the form of an assembly mounted to the vehicle as defined in claim 29;
selectively deploying a desired said element by disconnecting said desired said element from said assembly and/or said vehicle, while maintaining at least one of electrical continuity and aerodynamic conformality at least between remaining said elements of said assembly.

32. A method for carrying at least one external store on a vehicle, comprising:
forming the or each said stores as an element having a configuration comprising a corresponding external store element comprising a plurality of surfaces defining an exterior thereof, said surfaces comprising at least one facet; and
mounting the or each said external store element to the vehicle while maintaining at least one of electrical continuity and aerodynamic continuity between the or each said external store element and an adjacent external surface of the vehicle.
